(19) United States
(12) Patent Application Publication
(10) Pub. No.: US 2023/0088660 A1
(43) Pub. Date: Mar. 23, 2023

(54) IDENTITY-CONCEALING MOTION DETECTION AND PORTRAYING DEVICE

(71) Applicants: Ira DVIR, Beer Yaakov (IL); Ilia BAKHAROV, Kiryat Ono (IL)

(72) Inventors: Ira DVIR, Beer Yaakov (IL); Ilia BAKHAROV, Kiryat Ono (IL)

(21) Appl. No.: 17/802,320

(22) PCT Filed: Feb. 25, 2021
(86) PCT No.: PCT/IL2021/050214

§ 371 Date: Aug. 25, 2022

Related U.S. Application Data
(60) Provisional application No. 62/981,061, filed on Feb. 25, 2020.

(51) Int. Cl. G06T 7/20; G06T 5/00; H04N 7/18; H04N 5/77

(52) U.S. Cl. CPC G06T 7/20; G06T 5/002; H04N 7/183; H04N 5/77; G06T 2207/10016; G06T 2207/20192; G06T 2207/30201; G06T 2207/30232

(57) ABSTRACT

An identity-concealing motion detecting and portraying device, for privacy-preserving monitoring or surveillance, concealing the identity of detected moving subjects and their observed location and denying access to original video frames. The device includes a video camera that collects video frame images of an area; a volatile memory storing a video buffer, the video camera storing a stream of video frames in the buffer. A processor, for each pair of successive video frames in the video buffer, computes a simple difference frame of the pair; erases the first video frame of the pair from the volatile memory; and outputs the difference frames as portrayed motion video. The device may comprise an analytics module for detecting specific events with an alerts module to issue an alert to an external device. The difference frames and alerts may pass through a unidirectional “waterfall” link within the device, preventing access to the original video frames.

### FIELD OF THE INVENTION

The invention is in the field of video analysis for observation and surveillance, and in particular relates to a device that detects and portrays motion captured in video image frames while concealing the identities of subjects in the images.

### BACKGROUND TO THE INVENTION

“Smart” motion detectors, employing video cameras, are used in public locations and in private residences to alert of illegal intrusion, the presence of unauthorized people, and hazards. The detectors include motion analysis and object classification, using morphology and other known technologies.

U.S. Pat. No. 5,969,755 discloses a method to provide automatic content-based video indexing from object motion. Moving objects in video from a surveillance camera are detected in a video sequence using motion segmentation methods. Objects are tracked through segmented data. A symbolic representation of the video is generated in the form of annotated graphics describing the objects and their movement. A motion analyzer analyzes results of object tracking and annotates the graph motion with indices describing several events. The graph is then indexed using a rule-based classification scheme to identify events of interest such as appearance/disappearance, deposit/removal, entrance/exit, and motion/rest of objects. Clips of the video identified by spatio-temporal, event, and object-based queries are recalled to view the desired video.

U.S. Pat. No. 6,049,363 discloses object detection for scene change analysis, performed by a statistical test applied to data extracted from two images taken from the same scene from identical viewpoints. It is assumed that a single change region corresponding to an object that is present in one image but absence in the other is given. In the case of TV data, the test consists of measuring the coincidence of edge pixels in each image with the boundary of the change region. In the case of IR data, the tests consist of measuring the pixel intensity variance within the change region in each image.

### SUMMARY

So-called “stupid” motion detectors, such as those employing passive infrared (PIR) sensors, do not disclose the identity of detected subjects (persons and objects). They are therefore allowed to be used almost everywhere. However, existing “smart” motion detection and alerting devices are based on cameras, which present legal or regulatory conflicts in many countries, as they violate the privacy of the photographed subjects.

It is not only regulations (like the Helsinki Committee for Human Rights) that prevent the usage of such smart devices. Ordinary people are naturally reluctant to have such devices installed in their houses, as they do not want to find video clips, which were captured in their privacy, distributed in the web and social networks.

Smart motion detectors are focused on the analyses of the motion in the video frames, its detection and the classifying of the detected objects. They provide automatic and fast alert (by humans or machines). However, existing smart detectors are not bothered by issues of privacy or with the limitations where the disclosing of the pictured location is prohibited and/or unwanted.

An effective alert is an alert which has zero false alarms and zero misses of real alarms. As the best possible alert is probably one that transfers in real time the picture of the alert-causing event, it seems like there is no way of having an optimal alerting device without violating the privacy of the pictured subjects and the location itself (the detailed picture of which most people would not be happy to share).

The current invention relates to an identity-concealing motion detection and portraying device. The device prevents any leaking of detailed images or video—thereby preventing privacy violations—by discarding imagery data, which is acquired by the device during the processing of the data, while saving and transmitting only the portrayal of the motion.

In an exemplary embodiment, an identity-concealing motion detection and portraying device does not enable the pass-through of any imagery, such as video information. The imagery is used for the processing of the motion detection and then discarded by deletion or erasure from the device's memory. The imagery cannot be accessed for viewing or transmission. Only the processed data of the motion of the moving objects, which are monitored by the field-of-view of the device, is stored and can be shared by the device.

The invention therefore provides an identity-concealing motion detecting and portraying device, for privacy-preserving monitoring and/or surveillance by concealing the identity of detected moving subjects and their observed location and denying access to original video frames; the device comprises:
a. a video camera;
b. a volatile memory, stored thereon a video buffer, the video camera configured to store a stream of video frames in the video buffer;
c. a processor configured, for each pair of successive video frames in the video buffer, to
   i. compute the diff frames of the pair;
   ii. erase the first video frame of the pair from the volatile memory;
   iii. output the diff frames as portrayed motion video.

The invention further provides the above device, wherein the processor is further configured to smooth edges of the portrayed motion in the diff frames.

The invention further provides any one of the above devices, further comprising a wireless communication module (WiFi or cellular 3G/4G/5G etc.), configured to transmit real-time alerts of detected moving object or objects.

The invention further provides any one of the above devices, configured for setup enabling aiming the device to a desired field-of-view without revealing the location's actual image during the setup.

The invention further provides any one of the above devices, further configured to dynamically vary the frame rate of the analyzed video frames by constantly comparing motion estimation of the same video sequence applied simultaneously to pairs of frames spanning short and long time intervals, and adjusting the frame rate accordingly when comparably fast or slow motions are detected.

The invention further provides any one of the above devices, further configured to applying pixel acceleration motion detection, wherein each pixel value is replaced by its appropriate acceleration measure as estimated by taking the second derivative of the interpolation curve obtained from previous N frames.

The invention further provides any one of the above devices, wherein the video camera is separate from the rest of the device, and connected via any wired or wireless communication such as USB or MIPI.

The invention further provides any one of the above devices, further comprising a video analytics module configured to detect events computed from the diff frames, the video frames, or a combination thereof.

The invention further provides any one of the above devices, wherein the events comprise presence of an intruder, a fire alert, a facial recognition, a fall, a violent activity, or any combination thereof.

The invention further provides any one of the previous two devices, further configured to send alerts of the events to external devices.

The invention further provides the previous device, wherein the communication path said between said analytics module(s) and said alerting module includes a unidirectional waterfall data link.

The invention further provides any one of the previous four devices, further comprising an audio enhancement device, comprising

a. a microphone;

b. an audio buffer configured to store an audio signal collected by the microphone;

c. an audio stamp database, storing audio stamps of event sounds;

d. an audio analytics module configured to identify an audio event stored in the audio buffer by comparison with the audio stamps.

The invention further provides the previous device, wherein results of the audio analytics module is correlated with results of the video analytics module.

The invention further provides an identity-concealing motion detecting and portraying device, for privacy-preserving monitoring and/or surveillance by concealing the identity of detected moving subjects and their observed location and denying access to original video frames, the device comprising

a. a video camera configured to collect video frame images of an area;

b. a first section comprising
i. a first video buffer, the video camera configured to store a stream of the video frames in the video buffer;
ii. a processor configured, for each pair of successive video frames in the video buffer, to
   a) compute diff frames of the pair; and
   b) output the diff frames as portrayed motion video;

c. a second section comprising
i. a second video buffer configured to store a stream of the diff frames;
ii. a second processor configured to transfer the diff frames to a video encoder, the video encoder configured to encrypt the diff stream and output to an external network;
wherein a unidirectional waterfall link carries the diff frames from the first section to the second section.

The invention further provides the previous device, wherein the waterfall link comprises one or more of

a. a transmitter of the first section and a receiver of the second section;

b. a unidirectional serial connection;

c. a unidirectional optical fiber; and

d. an analog video link.

The invention further provides any of the abovementioned devices with a waterfall link, wherein the first processor is further configured to erase the first the video frame of the pair from the first video buffer.

The invention further provides any of the abovementioned devices with a waterfall link, wherein

a. the first section further comprises a first analytics module, configured to detect events computed from the video frames; and/or

b. the second section further comprises a second analytics module, configured to detect events computed from the diff frames; and

c. the second section further comprises an alerts module, configured to send alerts of the events to external devices.

The invention further provides the previous device, wherein the communication path between the analytics module(s) and the alerting module includes one or more additional unidirectional waterfall data links.

The invention further provides any of the abovementioned devices with a waterfall link, wherein the first section receives software updates via a non-wireless connection.

The invention further provides an identity-concealing motion detecting and portraying method, for privacy-preserving monitoring and/or surveillance by concealing the identity of detected moving subjects and their observed location and denying access to original video frames, the method comprising steps of

a. a video camera collecting video frame images in an area;

b. storing a stream of the video frame images in a video buffer of a volatile memory;

c. for each pair of successive video frames in the video buffer,
i. computing the diff frames of the pair;
ii. erasing the first video frame of the pair from the volatile memory;
iii. outputting the diff frames as portrayed motion video.

The invention provides the above method, further comprising a step of smoothing edges of the portrayed motion in the diff frames.

The invention further provides any one of the above methods, further comprising a step of a wireless communication module transmitting real-time alerts of detected moving object or objects.

The invention further provides any one of the above methods, further comprising a setup of aiming the device to a desired field-of-view without revealing the location's actual image during the setup.

The invention further provides any one of the above methods, further comprising a step of dynamically varying the frame rate of the analyzed video frames by constantly comparing motion estimation of the same video sequence applied simultaneously to pairs of frames spanning short and long time intervals, and adjusting the frame rate accordingly when comparably fast or slow motions are detected.

The invention further provides any one of the above methods, further comprising a step of applying pixel acceleration motion detection, wherein each pixel value is replaced by its appropriate acceleration measure as estimated by taking the second derivative of the interpolation curve obtained from previous N frames.

The invention further provides any one of the above methods, further comprising a step of providing the video camera is separate from the rest of the device, and connected via a wired or wireless communication.

The invention further provides any one of the above methods, further comprising a step of a video analytics module detecting events computed from the diff frames, the video frames, or a combination thereof

The invention further provides the previous method, wherein the events comprise presence of an intruder, a fire alert, a facial recognition, a fall, a violent activity, or any combination thereof.

The invention further provides any one of the previous two methods, further comprising a step of sending alerts of the events to external devices.

The invention further provides any one of the previous three methods, further comprising a step of providing an audio enhancement device, comprising
a. a microphone;
b. an audio buffer configured to store an audio signal collected by the microphone;
c. an audio stamp database, storing audio stamps of event sounds;
d. an audio analytics module configured to identify an audio event stored in the audio buffer by comparison with the audio stamps.

The invention provides the previous method, further comprising a step of correlating results of the audio analytics module with results of the video analytics module.

### BRIEF DESCRIPTION OF THE DRAWINGS

FIG. 1 is a clear portrayal of the contours of a moving subject in the device's field-of-view, produced according to some embodiments of the invention.

FIG. 2 is a functional block diagram an of an identity-concealing motion detecting and portraying device, according to some embodiments of the invention.

FIG. 3 illustrates a process in which the earlier of the two video frames producing a differential frame is erased from the RAM after the diff frame is computed.

FIGS. 4 and 5 show, respectively, an image of a location with no moving subjects and a non-disclosing view of the image produced according to some embodiments of the invention.

FIG. 6 is a functional block diagram of an of an identity-concealing motion detecting and portraying device with AI analytics, according to some embodiments of the invention.

FIG. 7 is a functional block diagram of an identity-concealing motion detecting and portraying device in which AI analysis of specific events and features is based exclusively on diff images, according to some embodiments of the invention.

FIG. 8 shows a comparison between images from a scene of a falling subject and identity-concealing motion portrayals of the scene at the time of the images.

FIG. 9 shows morphological signatures of a dog, a woman, and a man, which can be compared with identity-concealing motion portrayals which can be used to determine the type of moving subject in an identity-concealing motion portrayal.

FIG. 10 is a functional block diagram of an identity-concealing motion detecting and portraying device, where AI analysis of specific events and features is made from the full visual data of video frames and sequences, according to some embodiments of the invention.

FIG. 11 is a functional block diagram of an audio enhancement 500 usable with an identity-concealing motion detecting and portraying device, according to some embodiments of the invention.

FIG. 12 is a functional block diagram of an of an identity-concealing motion detecting and portraying device 600 with a unidirectional “waterfall” data link, according to some embodiments of the invention.

### DETAILED DESCRIPTION

In this disclosure, the term “motion portrayal” refers to providing images facilitating detection of motion (by human or machine). In exemplary embodiments, the provided images accentuate the edges of moving objects.

The term “full visual video data” or simply “full visual data” refers to unprocessed video frames as initially acquired by a video camera or repetitive still camera.

“Visual data” can refer as well to video frames that have been processed to extract only an outline of moving subjects, as further described herein.

“Non-visual data” refers to data about motion in a video (full-visual or visual) extracted from the video frames.

In an exemplary embodiment, the current invention comprises an identity-concealing motion detecting and portraying device that does not store acquired visual and/or IR video data in any externally-accessible memory. The acquired video data is stored temporarily for processing on the device's random-access memory (RAM), and it is cleared from the RAM immediately after being processed.

In one possible implementation of the current invention, N video frames are stored in the device's RAM, while the Nth frame is compared with a successive frame (e.g., the N+1st, N+2nd, or N+nth frame) are compared using motion estimation and image comparison technologies, detecting the edges of any present moving objects.

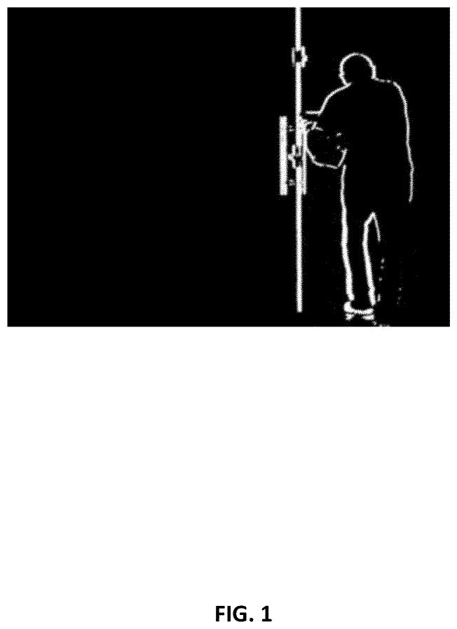

Video cameras sample their field-of-view a few times per second, typically from 24 to 60 frames per second (FPS). In some embodiments, the device computes a simple difference between successive video frames. Such a differential frame is called a diff frame (or simply a diff). In such embodiments, once the device is static (not panning, tilting, or zooming) it computes a simple difference between successive frames—whether consecutive frames N+1 or by skipping to N+2 or N+n—creating a clear portrayal of the contours of a moving subject in the device's field-of-view, as demonstrated in FIG. 1. The portraying of the motion, in terms of thickness of the contours, in pixels, is correlated to the distance the moving subject passed between the frames. The greater the time interval between the subtracted frames, the thicker will be the contour line of the difference image of the moving subject. The thickness is also affected by the speed of the motion. The quicker the motion, the thicker will be the contour of the moving object.

Although video cameras capture typically 24 to 60 FPS, for the current invention a lower frame rate of 1 to 12 FPS is typically sufficient. However, a large interval of time (e.g., more than 100 ms) may produce a diff image that discloses identifying details of fast-moving subjects. Enhancing the contrast and/or reducing the brightness of the diff image could be one way of discarding such details for concealing the identity of the moving objects. Another way could be to reduce the color depth to 8, 4, or even 2 colors. Additionally (or alternatively) smoothing the contours and thinning the lines by one of many edge detection techniques known in the art, and/or even vectorizing the diff images for reduced data size/rate for optimized transmission.

In some exemplary embodiments, the identity-concealing motion detecting and portraying device does not enable the pass-through of any imagery. Video information is used for processing of the motion detection is discarded and deleted/erased from the device's memory, and cannot be accessed for viewing or transmission. Only the processed data of the motion of the moving objects, which are monitored by the field-of-view of the device, is stored and can be shared by the device.

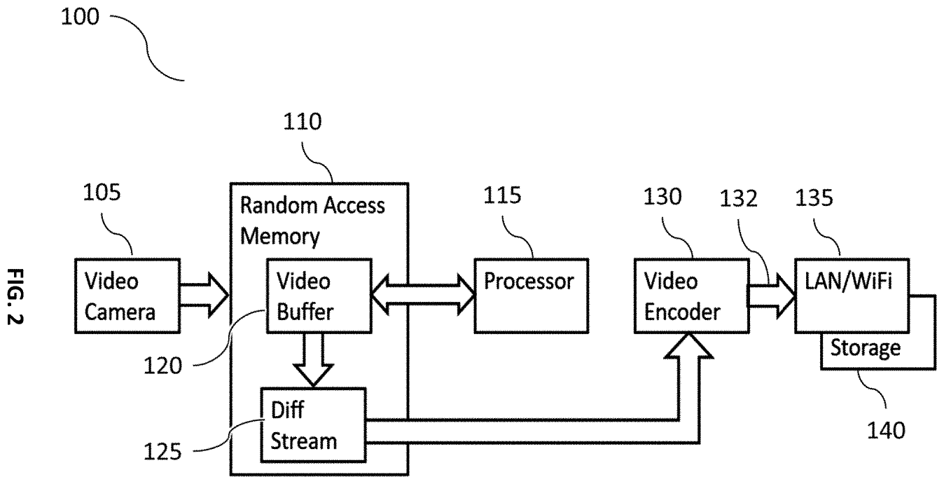

Reference is now made to FIG. 2, a functional block diagram an of an identity-concealing motion detecting and portraying device 100, according to some embodiments of the invention. The device 100 comprises a video camera 105, one or more volatile memories (RAM) 110, one or more processors 115 (collectively, “the processor”), a video encoder 130, a communication means 135, and one or more storage media 140.

The video camera 105 is a camera sensor attached to the required hardware for acquiring video frames and feeding them to a video buffer 120 in the RAM 105, and typically nothing more. The video camera 105 is positioned to capture an image of a surveilled area or area under observation. Typically, the video camera 105 acquires image frames at frame rates of 1-12 FPS. The video camera 105 can be an integral component of the device 100 according to the current invention, although it is possible to implement the current invention by connecting an off-the-shelf video camera (or still camera capable of acquiring video), to an independent device designed according to the current invention.

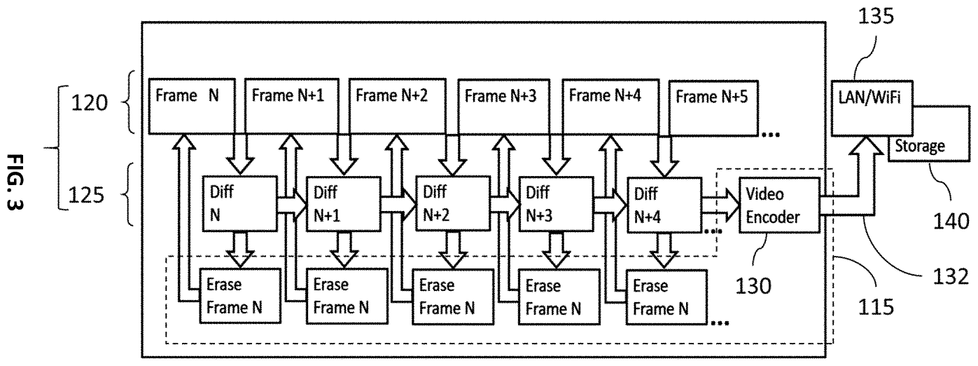

Typically, the processor 115 and the video encoder 130, which encodes the diff stream 125 to produce the output stream 132, are part of different devices. The video encoder 130 does not have any access to the original video frames. The only data the video encoder 130 can access is that of the diff images from the diff stream 125. The diff images are sufficiently obscure to maintain the privacy of the location and objects within the field-of-view of the device 100. In alternative embodiments, the processor 115 includes the video encoder 130 (e.g., the function of encoding the diff stream 125 to produce the output stream 132 is done by the processor). Referring to FIG. 3, in such embodiments the processor 115 implements a process in which the earlier of the two video frames producing the diff frame is erased from the RAM 110 after the diff frame is computed. This process denies the video encoder 130 any access to the original video frames.

Once the diff images are produced, the original video frames are erased from the video buffer 120. Upon creation of the diff stream 125, the original video frames data can no longer be accessed, because it no longer exists. The diff frames can be coded (at their original or at reduced resolution) and wrapped as a video stream, which can be transmitted over wire or wirelessly for remote monitoring of the location.

The current invention enables a simple and effective alert whenever a certain level of motion is detected. In some embodiments, the processor 115 counts the number of pixels measuring different light intensity between successive video frames in the video buffer 120. In some embodiments, the processor reduces diff frames to 1-bit color depth and counts the number of white or black pixels in the diff frames.

A person skilled in the art, after learning the teachings disclosed herein, would be able to specify different areas in the monitored field-of-view of the device, according to the current invention, and alert for motion in specified areas or ignore such motion according to a defined specification.

The contours of the moving objects can be classified based on simple morphology, discriminating between pets, birds, humans, etc. by any means known in the art.

As the device according to the current invention cannot output an image of the acquired video, but only the difference between successive frames (or any other portrayal of the contours of moving objects in the device's field-of-view). The current invention enables simply setting the device's field-of-view without disclosing an identifiable image of the location.

In some embodiments, the device is set up mode so that acquired frames are synthetically shifted a few pixels (either horizontally or vertically or both), as if the whole scene is moving. Such synthetic motion enables output a diff image or diff video stream of the contours of the objects in the device's field-of-view.

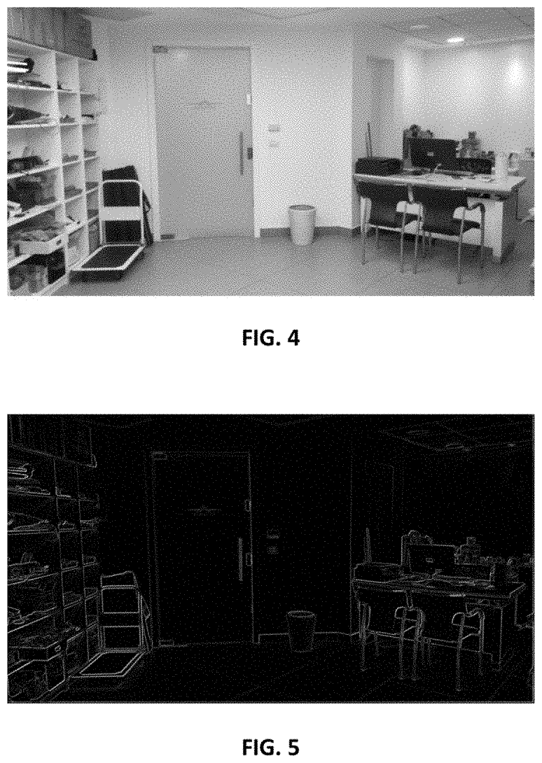

FIG. 4 presents a location with no moving subjects. A static device according to the current invention will present a blank image (black, gray, white, or any other color) of the device's field-of-view and will not display any image. The resulting absence of reference features presents a problem for setting the device for monitoring a desired field-of-view.

As a possible solution to the problem, according to some embodiments the processor implements a non-disclosing view of the scene. The view is achieved by shifting the successive acquired frames a few pixels horizontally and a few pixels vertically from frame N to frame N+1 and the same shift is applied again shifting N+3 from N+2 and so on (one frame in its original position, with the following frame shifted). The result is demonstrated in FIG. 5.

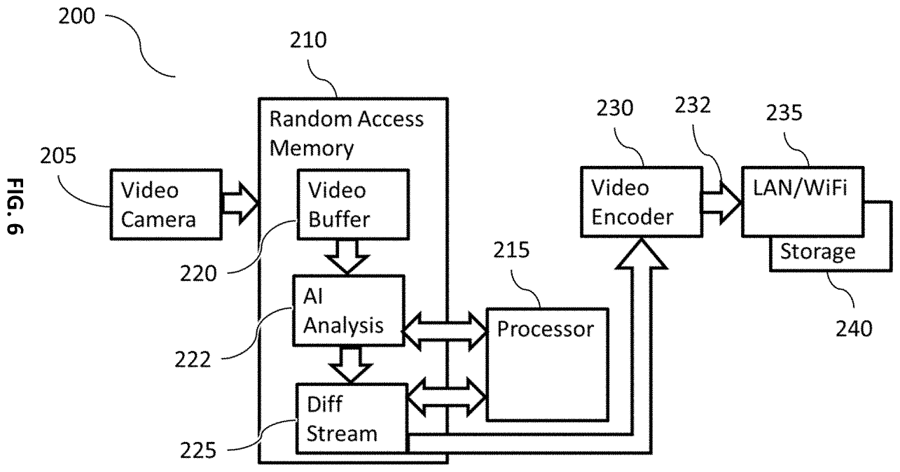

Reference is now made to FIG. 6, a functional block diagram of an of an identity-concealing motion detecting and portraying device 200 with a video analytics module 222, according to some embodiments of the invention. The analytics module 222 may employ artificial intelligence (AI), as shown.

The video analytics module 222 is introduced between the video buffer 220 and the diff stream 225, maintaining the elements and functionality of the system described in relation to FIG. 2. Frames acquired by the video camera 205 are fed to the video buffer 220. Before the frames are compared for creating the privacy-protecting diff images, the video analytics module 222 analyzes video frames and short video sequences, using the state-of-the-art methods for face recognition, fall detection, lack of motion, and/or other hazardous situations.

The video analytics module 222 stores the results of the analysis are non-visual data. Such non-visual data may include for example, when dealing with face recognition, only the 2D and/or 3D geometric ratios and relative angles of the facial features (eyes, nose, nostrils, forehead, eyebrows, ears, chin, hair-line etc.) of the analyzed subjects.

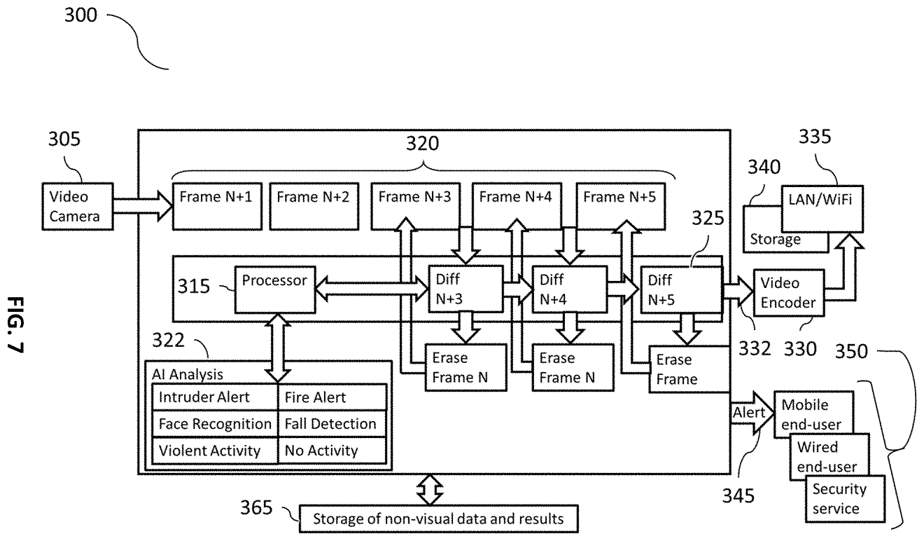

Reference is now made to FIG. 7, a functional block diagram of an identity-concealing motion detecting and portraying device 300, where video analysis 322 of specific events and features is based exclusively on diff images.

Event detection from the diff images, by the video analytics module 322, can be implemented by any means known in the art. The diff images may ease the effort of analyzing the data, as subjects are separated from the static scene in which they are located. For example, if the colors of the objects and the background are similar, it may be easier to analyze motion based on edge detection of pure diff between frames, because the static background in such cases is not present in the diff images. (In other cases, however, diff image analysis could be more complex due to the lack of detailed visual data. For example, detecting falls and human postures for example may be done more accurately when the full visual data is available, as described herein in relation to FIG. 7)

Employing the device 300 to detect the entrance of a subject (intruder) into the scene is a straightforward task: any means known in the art may be employed for filtering noise from the diff images and summing the number of groups of adjacent pixels (blobs) of above a threshold pixel number as they move into the scene.

Frames are fed from a video camera 305 to the video buffer 320 of the device's volatile memory. The frames are compared and frames of standard diff images or enhanced diff images are created in the diff stream 325. Immediately after their creation, the original video frames in the video buffer 320 are erased (and written over).

In the next step, sequences of such diff frames are processed, analyzing the quantity of moving pixels, which are contained in groups of adjacent pixels (blobs), and the vector of the motion on such groups of pixels, compared to the motion of such groups of pixels (if exists) in the previous frames.

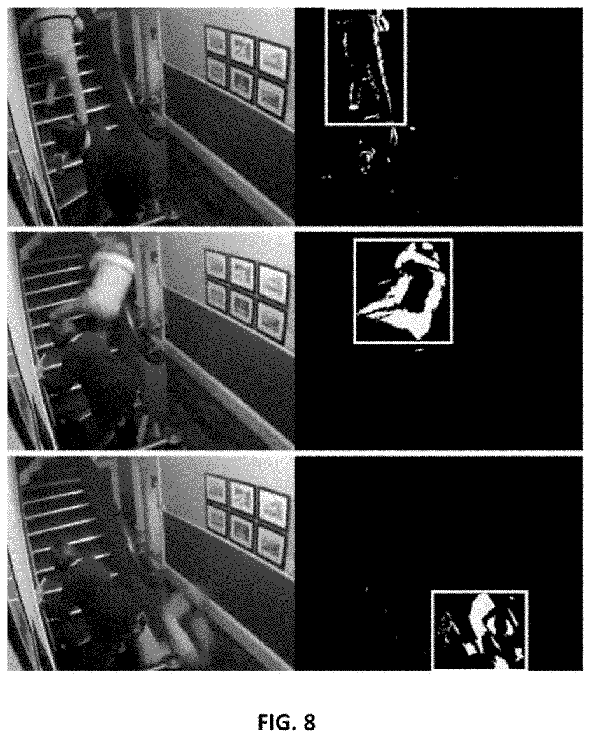

For example, detecting a fall may be implemented by a known technique, such as calculating the acceleration of moving diff pixels vertically, while a rectangular enveloping such pixels changes the ratio between its horizontal and vertical dimensions significantly. An abrupt motion of rather large amount of diff pixels, as depicted in FIG. 8, combined with a change of the H:V ratio of the enveloping rectangular from V>H to V≤H, most probably indicates a fall.

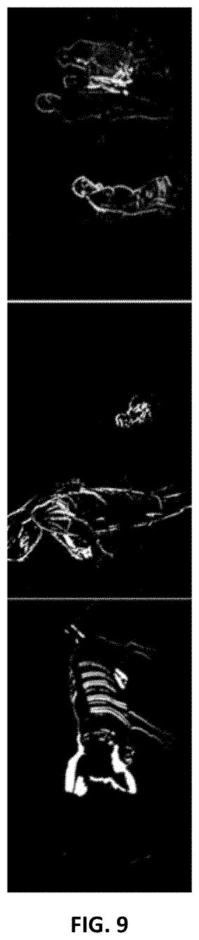

According to the current invention an alert could be verified by a morphological comparison of the signatures of the moving objects in the scene (man, woman, child. pet, or some pre-defined object), as illustrated in FIG. 9. The techniques for performing comparisons and matching such morphological stamps can be implemented by any means known in the art.

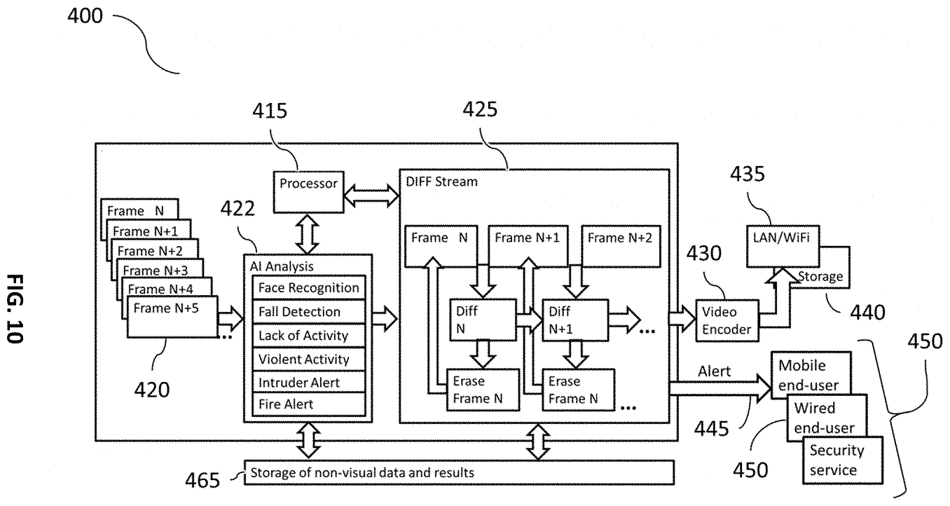

Reference is now made to FIG. 10, a functional block diagram of an identity-concealing motion detecting and portraying device 400, where analysis 422 of specific events and features is made from the full visual data of the video frames and sequences, while stored in the video buffer 420, according to some embodiments of the invention, before creating the diff frames and discarding the full visual data.

The full-video analytics module 422 may be the sole analytical component of the device 400, or it can be used as an assisting decision-making component, which is used in combination with the analytics of the diff frames, as described herein (e.g., diff-frame analytics module 322 in FIG. 7). Verifying positive identification of triggering events by correlating the analytics of the full visual frames with the analytics of the diff frames, could lead to more accurate results, minimizing the percentage of false positive and false negative identifications.

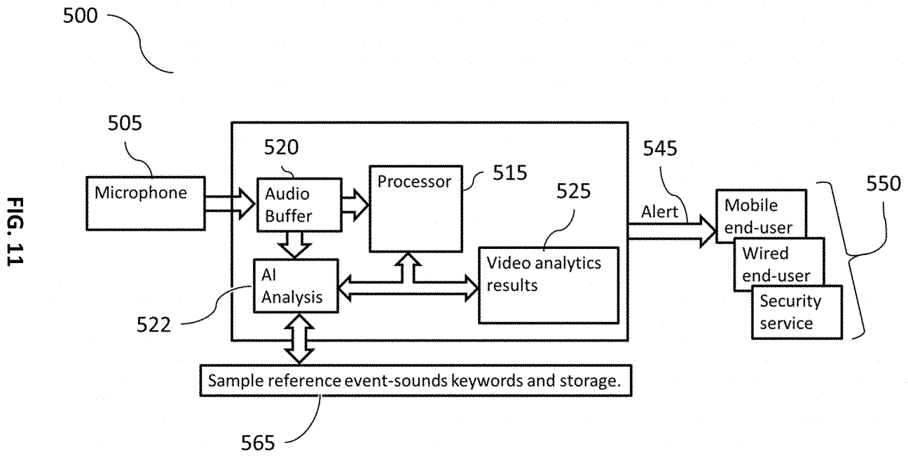

Reference is now made to FIG. 11, a functional block diagram an audio enhancement device 500 usable with an identity-concealing motion detecting and portraying device.

Just like with the video, the current invention conceals the identity of the monitored location and people by preventing the streaming of audio from the device.

Still, the device 500 is designed to identify specific events by comparing outlying audio signals to stored audio stamps 565 stored in the device 500. Such stored audio stamps 565 may include, among other stamps, various sounds of falls, triggering sounds and/or words, which can be also added by recording the user/s.

Once an audio triggering event is detected it could be correlated in case of doubt with the video analysis results of the same time, minimizing false negative and false positive alerts.

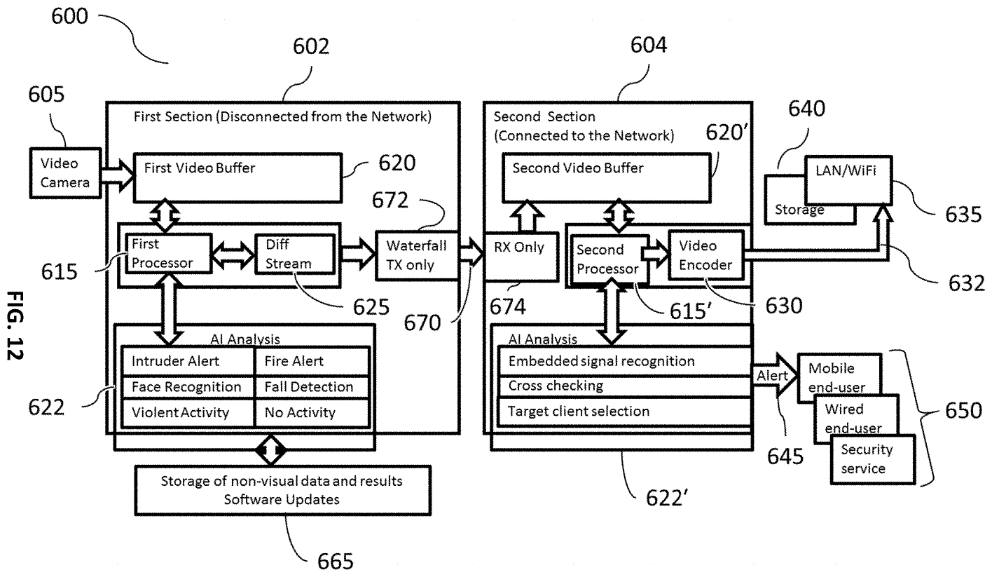

Reference is now made to FIG. 12, a functional block diagram of an of an identity-concealing motion detecting and portraying device 600 with a one-way “waterfall” data link 670, according to some embodiments of the invention.

The device 600 is divided into a first section 602 and a second section 604. The first section 602 performs the first (initial) phase of acquiring the video frames. A processor 615 of the first section computes diff frames. The first section may comprise an analytics module 622 that performs analytics on the full visual video frames. Diff frames are fed to the frame buffer 620′ of the second section 604 as the source video frames of the second section 604. The diff frames are fed over a unidirectional “waterfall” link 670. In the embodiment shown, the waterfall link 670 is implemented by a single transmitter 672 of the first section 602 and a single receiver 674 of the second section 604. In alternative embodiments, the waterfall link may be implemented by a unidirectional serial connection, over a unidirectional optical fiber, as analog video (converted from digital to analog, sent over cable and then digitized, coded and broadcast when required), and/or similar unidirectional means.

A video encoder 630 of the second section 604 encodes the diff images as a video stream 632 and broadcasts the stream 632 when required. The second section 604 further issues alerts according to the full-visual video analytics (by an analytics module 622 of the first section 602) and/or diff images analytics (by an analytics module 622′ of the second section 604).

The diff frames are the only visual output of the first section 602 to the second section 604. Furthermore, because the waterfall link 670 is unidirectional and the external network 635 is connected only to the second section 604, the first section 602 is unable to receive external requests from the network 635 for the full visual data. (Only portions of the device 600 downstream from the waterfall link 670 may be externally accessed.) Therefore a hacker has no way to access and steal the full visual data; cyber-privacy is thereby preserved.

In preferred embodiments both the first section 602 and the second section 604 each possess an independent memory, including video buffers 620, 620′ and independent processors 615, 615′.

In some embodiments, a video encoder 630 encrypts the output video of the second section 604, thereby requiring decryption at the client's end.

In some embodiments, the analytics module 622 of the first section 602 is connected to the first analytics module 622 and receives software updates via a non-wireless connection, such as an SD card or USB, thereby obviating the need to be connected to a network. Preferably, the first section analytics module 622 uses encrypted files.

In the device 600 of FIG. 12, a waterfall link 670 is placed at the connection carrying the diff frames. Alternatively, or in addition, unidirectional waterfall links may be placed at the connections transmitting the video stream 632 and/or the alerts 645 to the external network 635. For example, the video encoder 630 may have only a WiFi transmitter to the external network 635 and no receiver.

The alert module 645 may, for example, receive, over a waterfall link, embedded video signals such as colored pixels, such as macroblocks of 8×8 pixels in 1 of e.g., 16 or 24 colors, each one of the colors associated with a specific event. Only the alert module of the device can possibly be accessed from external devices 650 (or their networks). The portions of the device upstream from the waterfall link carrying the alerts are isolated from external access.

The waterfall link carrying the alerts may be implemented, for example, by a serial transmission cable.

### Table of Referenced Features

| Reference Number(s) | Feature name |
|---|---|
| 100, 200, 300, 400, 600 | Identity-concealing motion detecting |
| | and portraying device |
| 105, 205, 305, 605 | Video camera |
| 110, 210, 310 | Random access memory |
| 115, 215, 315, 415, 515 | Processor |
| 120, 220, 320, 420 | Video buffer |
| 125, 225, 325, 425, 625 | Diff stream |
| 130, 230, 330, 430, 630 | Video encoder |
| 132, 232, 332, 432, 632 | Output stream |
| 135, 235, 335, 435, 635 | LAN/WiFi |
| 140, 240, 340, 440, 640 | Storage |
| 222, 322, 422 | Video analytics module (may employ AI) |
| 345, 445, 545, 645 | Alerting module |
| 350, 450, 550, 650 | External devices (mobile device, wired |
| | device, and/or security service device) |
| 365, 465, 665 | Non-visual results database |
| 500 | Audio enhancement device |
| 505 | Microphone |
| 520 | Audio buffer |
| 522 | Audio analytics module |
| 525 | Video analytics results |
| 565 | Audio stamps database |
| 602 | First section (of a partitioned device) |
| 604 | Second section |
| 615 | First section processor |
| 615′ | Second section processor |
| 620 | First section video buffer |
| 620′ | Second section video buffer |
| 622 | First section video analytics module |
| | (can be AI) |
| 622′ | Second section video analytics module |
| | (can be AI) |
| 670 | Waterfall data link |
| 672 | Transmitter of waterfall data link |
| 674 | Receiver of waterfall data link |

It is understood that features presented with different reference numbers having a common name are not necessarily identical.

1. An identity-concealing motion detecting and portraying device, for privacy-preserving monitoring and/or surveillance by concealing the identity of detected moving subjects and their observed location and denying access to original video frames, said device comprising
a. a video camera configured to collect video frame images of an area;
b. a volatile memory, stored thereon a video buffer, said video camera configured to store a stream of said video frames in the video buffer;
c. a processor configured, for each pair of successive video frames in the video buffer, to
i. compute diff frames of the pair;
ii. erase the first said video frame of the pair from the volatile memory;
iii. output the diff frames as portrayed motion video.

2. The device of claim 1, wherein the processor is further configured to smooth edges of the portrayed motion in the diff frames, present a symbolic graphic illustration of a moving subject, or a combination thereof.

3. The device of claim 1, further comprising a wireless communication module (WiFi or cellular 3G/4G/5G etc.), configured to transmit any combination of
a. real-time alerts of detected moving object or objects;
b. said diff frames; and
c. symbolic graphic illustrations of moving subjects.

4. The device of claim 1, configured for setup enabling aiming the device to a desired field-of-view without revealing the location's actual image during said setup.

5. The device of claim 1, further configured to dynamically vary the frame rate of the analyzed video frames by constantly comparing motion estimation of the same video sequence applied simultaneously to pairs of frames spanning short and long time intervals, and adjusting the frame rate accordingly when comparably fast or slow motions are detected.

6. The device of claim 1, further configured to applying pixel acceleration motion detection, wherein each pixel value is replaced by its appropriate acceleration measure as estimated by taking the second derivative of the interpolation curve obtained from previous N frames.

7. The device of claim 1, wherein said video camera is separate from the rest of the device and connected via a wired or wireless communication.

8. The device of claim 1, further comprising
a video analytics module configured to detect events computed from the diff frames, the video frames, or a combination thereof,
wherein said events comprise presence of an intruder, a fire alert, a facial recognition, a fall, a violent activity, or any combination thereof; and
an alerting module configured to send alerts of said events to external devices.

9. (canceled)

10. (canceled)

11. The device of claim 1, wherein the communication path said between said analytics module(s) and said alerting module includes a unidirectional waterfall data link.

12. The device of claim 1, further comprising an audio enhancement device, comprising
a. a microphone;
b. an audio buffer configured to store an audio signal collected by the microphone;
c. an audio stamp database, storing audio stamps of event sounds; and
d. an audio analytics module configured to identify an audio event stored in said audio buffer by comparison with said audio stamps.

13. The device of claim 1, wherein results of said audio analytics module is correlated with results of said video analytics module.

14. An identity-concealing motion detecting and portraying device, for privacy-preserving monitoring and/or surveillance by concealing the identity of detected moving subjects and their observed location and denying access to original video frames, said device comprising
a. a video camera configured to collect video frame images of an area;
b. a first section comprising
i. a first video buffer, said video camera configured to store a stream of said video frames in the video buffer;
ii. a first processor configured, for each pair of successive video frames in the video buffer, to
a) compute diff frames of the pair; and
b) output the diff frames as portrayed motion video;
c. a second section comprising
i. a second video buffer configured to store a stream of said diff frames;
ii. a video encoder;
iii. a second processor configured to transfer said diff frames to the video encoder, said video encoder configured to encrypt said diff stream and output to an external network;
wherein a unidirectional waterfall link carries said diff frames from said first section to said second section.

15. The device of claim 14, wherein said waterfall link comprises one or more of
a. a transmitter of the first section and a receiver of the second section;
b. a unidirectional serial connection;
c. a unidirectional optical fiber; and
d. an analog video link.

16. The device of claim 14, wherein said first processor is further configured to erase the first said video frame of the pair from the first video buffer; and wherein
a. said first section further comprises a first analytics module, configured to detect events computed from the video frames; and/or
b. said second section further comprises a second analytics module, configured to detect events computed from the diff frames; and
c. said second section further comprises an alerts module, configured to send alerts of said events to external devices.

17. (canceled)

18. The device of claim 16, wherein the communication path between said analytics module(s) and said alerting module includes one or more additional unidirectional waterfall data links.

19. (canceled)

20. An identity-concealing motion detecting and portraying method, for privacy-preserving monitoring and/or surveillance by concealing the identity of detected moving subjects and their observed location and denying access to original video frames, said method comprising steps of
a. obtaining the device of claim 1;
b. the video camera collecting video frame images in an area;
c. storing a stream of said video frame images in the video buffer of the volatile memory;
d. for each pair of successive video frames in the video buffer,
i. computing the diff frames of the pair;
ii. erasing the first said video frame of the pair from the volatile memory; and
iii. outputting the diff frames as portrayed motion video.

21. (canceled)

22. The method of claim 20, further comprising a step of a wireless communication module transmitting
real-time alerts of detected moving object or objects.

23. The method of claim 20, further comprising a setup of aiming the device to a desired field-of-view without revealing the location's actual image during said setup.

24. The method of claim 20, further comprising
a. a step of dynamically varying the frame rate of the analyzed video frames by constantly comparing motion estimation of the same video sequence applied simultaneously to pairs of frames spanning short and long time intervals, and adjusting the frame rate accordingly when comparably fast or slow motions are detected;
b. a step of applying pixel acceleration motion detection, wherein each pixel value is replaced by its appropriate acceleration measure as estimated by taking the second derivative of the interpolation curve obtained from previous N frames; and
c. a step of providing the video camera is separate from the rest of the device, and connected via a wired or wireless communication.

25. (canceled)

26. (canceled)

27. The method of claim 20, further comprising
a. a step of a video analytics module detecting events computed from the diff frames, the video frames, or a combination thereof, wherein said events comprise presence of an intruder, a fire alert, a facial recognition, a fall, a violent activity, or any combination thereof; and
b. a step of sending alerts of said events to external devices.

28. (canceled)

29. (canceled)

30. The method of claim 27, further comprising a step of providing a unidirectional waterfall data link along the communication path between said analytics module and send alerting module.

31. The method of claim 27, further comprising a step of providing an audio enhancement device, comprising
a. a microphone;
b. an audio buffer configured to store an audio signal collected by the microphone;
c. an audio stamp database, storing audio stamps of event sounds;
d. an audio analytics module configured to identify an audio event stored in said audio buffer by comparison with said audio stamps.

32. The method of claim 31, further comprising a step of correlating results of said audio analytics module with results of said video analytics module.

33. (canceled)

34. (canceled)

35. (canceled)

36. (canceled)

37. (canceled)

38. (canceled)
